(19) United States
(12) Patent Application Publication
(10) Pub. No.: US 2002/0073321 A1
(43) Pub. Date: Jun. 13, 2002

(54) Fraud prevention for remote transactions

(76) Inventor: N. Stephan Kinsella, Houston, TX (US)

Correspondence Address: APPLIED OPTOELECTRONICS, INC., 13111 JESS PIRTLE BLVD., SUGAR LAND, TX, 77478, US

(21) Appl. No.: 09/733,664

(22) Filed: Dec. 8, 2000

(51) Int. Cl. H04L 9/00

(52) U.S. Cl. 713/183

(57) ABSTRACT

A method, apparatus, storage medium, and propagated signal for verifying possession of a user code by a user using a data entry terminal. According to an embodiment, a scramble key is generated. The scramble key is provided to the user and the user prompted to generate an input code by modifying the user code in accordance with the scramble key. The input code is then received from the user. In a further embodiment, it is determined whether the user used the user code to generate the input code, and access by the user of an account associated with the user is permitted only if the user is determined to have used the user code to generate the input code.

### BACKGROUND OF THE INVENTION

1. Field of the Invention

The present invention relates to remote or public account transactions and, in particular, to fraud prevention for such transactions.

2. Description of the Related Art

Often users of accounts, such as telephone calling card accounts, bank accounts, or credit card accounts, are able to make charges on their accounts or access their accounts from remote or public terminals such as telephones with touch-tone keypads. For instance, a person having a telephone calling card account typically has both an account number and sometimes an extra extension in the form of a PIN. In order to place a telephone call and have the long-distance charges charged to the user's account, the user may dial the desired destination telephone number, and, upon a special voice or tone prompt, enter the account and PIN number.

This may be done when, for some reason, the user does not wish to dial directly from the telephone being used, for instance if the telephone is a residence or business telephone of another, or if the user is using a pay phone (for example at an airport) and does not wish to deposit cash directly into the telephone or use a debit card. Users may also enter numbers such as banking account numbers by depressing the appropriate number keys on the telephone's keypad when desiring to access information or make a transaction regarding the bank account.

Thus, users having accounts often publicly enter account numbers and associated PINs or related information into the telephone or other remote terminal being utilized. The information may also be spoken orally by the user if the option is available.

One problem in the use of such remote entry of account information lies in the possibility of an unauthorized third party eavesdropping in some manner during the user's supplying of this information at the remote terminal. For instance, a third party at an airport or public sidewalk near a pay phone may spy on the numbers that users enter into the keypad, and may thereby learn the user's account and/or PIN number. This information can be used to the detriment of the user and/or the company which is in control of the account (“account company”). For instance, credit card or calling card or banking account fraud may follow once an unauthorized third party is able to glean such information.

One prior art method for providing fraud protection for card transactions is described in U.S. Pat. No. 5,311,594, issued May 10, 1994 to Penzias (“Penzias”), the entirety of which is incorporated herein by reference. In the system described in Penzias, several pieces of prestored information are stored that are associated with each user. When the user wishes to engage in a card transaction, the user is requested to supply one of these pieces of information or information derived from one of these prestored pieces of information as authentication information. The particular piece of information about which the user is queried is randomly selected from the prestored set of pieces of information. In the Penzias invention, however, it is still possible for a thief to eavesdrop and learn of confidential information supplied by the user, even if the thief's ability to use this information is minimized since the type of authentication information requested is randomly selected and thus may not be asked again for several card transaction attempts. For example, the user may be asked to supply the user's mother's maiden name, which may be, for example, “Jones.” The user then responds by saying “Jones,” which information may be overheard. The eavesdropper may not know exactly what question this answer is in response to, but because it sounds like a proper name, the eavesdropper may be able to guess that this is some proper name associated with the user, such as the user's mother's maiden name.

Other problems include the fact that the set of prestored information must either be fairly small, which reduces the fraud prevention benefits of Penzias, or the user must supply a large amount of prestored types of information to the account company, such as birthdates, mother's maiden name, etc., which may raise privacy, confidentiality, or ease-of-use concerns for some users.

There is, therefore, a need for additional and improved methods and systems for minimizing or eliminating the possibility of fraud when users access accounts or supply information from remote terminals.

### SUMMARY

A method, apparatus, storage medium, and propagated signal for verifying possession of a user code by a user using a data entry terminal. According to an embodiment, a scramble key is generated. The scramble key is provided to the user and the user prompted to generate an input code by modifying the user code in accordance with the scramble key. The input code is then received from the user. In a further embodiment, it is determined whether the user used the user code to generate the input code, and access by the user of an account associated with the user is permitted only if the user is determined to have used the user code to generate the input code.

### BRIEF DESCRIPTION OF THE DRAWINGS

These and other features, aspects, and advantages of the present invention will become more fully apparent from the following description, appended claims, and accompanying drawings in which:

FIG. 1 depicts a telephone calling card system in accordance with a preferred embodiment of the present invention; and

FIG. 2 is a flow chart illustrating a method of operation of the data system of FIG. 1, in accordance with a preferred embodiment of the present invention.

### DESCRIPTION OF THE PREFERRED EMBODIMENT

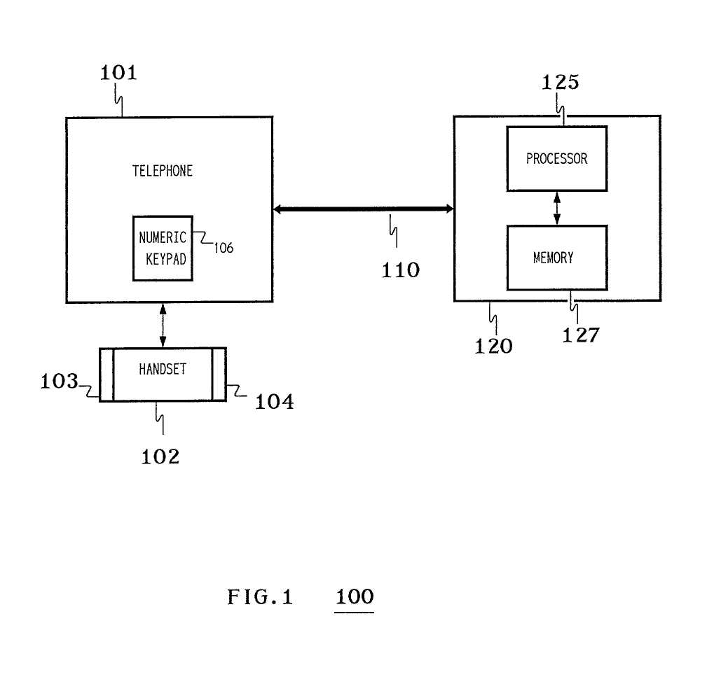

Referring now to FIG. 1, there is shown a telephone calling card system 100, in accordance with a preferred embodiment of the present invention. Calling card system 100 comprises data entry terminal 101, which comprises numeric keypad 106, and handset 102, which comprises speaker portion 103 and microphone portion 104. Data entry terminal 101 is connected remotely via communications channel 110 to central computer 120, which comprises processor 125 and memory 127. Channel 110 may comprise an integrated services data network (ISDN) link, plain-old telephone service (POTS) line, or other suitable communications channel, including wireless links. Processor 125 may be a general-purpose microprocessor or other suitable microprocessor. Memory 127 may comprise mass storage devices such as hard drives, compact-disk drives, random-access memory, and the like.

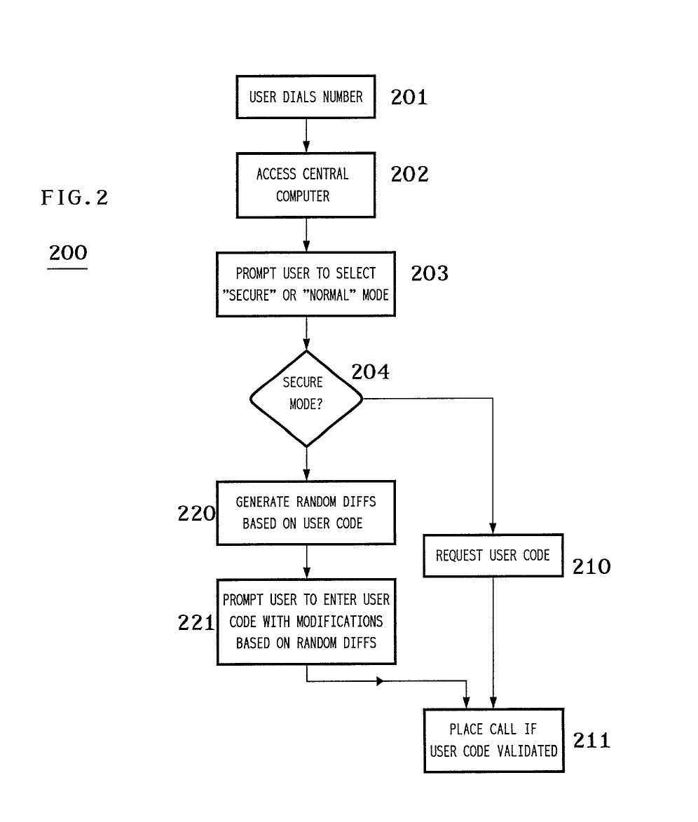

Referring now to FIG. 2, there is shown a flow chart 200 illustrating a method of operation of system 100 of FIG. 1, in accordance with a preferred embodiment of the present invention. In a typical use of the preferred embodiment, a user places a telephone call from a terminal in a place where it is possible that an unauthorized third party can potentially eavesdrop on information supplied by the user when the user communicates with a remote party (machine or human) via the data entry terminal 101. For example, the information can be supplied by the user speaking words into a telephone handset of terminal 101 or depressing keys of a keypad 106 of terminal 101. This may be done, for example, when the user makes a telephone call and thereby accesses a company (such as a human agent or automated computer of the company) in order to supply the information to the company to make some type of account transaction. The account transaction may involve supplying an account and/or PIN code to a long distance service company in order to charge a long distance call or other type of transaction to the user's account. The term “user code” will be generally used herein to refer to information to be provided by the user, via data entry terminal 101, to a remote company or agent, which user code is typically information that is desired to be secure and confidential.

In the present invention, the user code is known to the computer or other agent of the account company (e.g. the company having the account which the user wishes to charge for a given transaction). The user dials a telephone number which causes the account company's central computer 120 to be accessed (steps 201 and 202 of FIG. 2). In conventional systems, the central computer would ask the user to enter various information, e.g. a user code. In an embodiment of the present invention, instead of requesting the user to provide his user code (e.g., PIN number or account number followed by PIN number), central computer 120 prompts the user to select either “secure” or “normal” mode (step 203). For example, the user may enter “1” on numeric keypad 106 for “secure” mode or “0” for “normal” mode, in response to instructions supplied at speaker 103 of handset 102. If secure mode is not selected (step 204), then the user code is requested as normal (step 210). For example, a standard “tone” noise may play for the user to indicate that the user code should be entered as normal. If the user code is validated by central computer 120 (for instance by processor 125 checking user records stored in a database in memory 127), then the call is placed, as will be understood (step 211).

If, however, secure mode is selected, then central computer 120 generates a random scramble key and a scrambled user code which is related to the user code in accordance with the random scramble key. The random scramble key is such that it can be used to modify the user code to result in the scrambled user code.

In one embodiment, the scramble key consists of random digits used to modify individual digits of the user code, to result in a scrambled user code having the same number of digits as the original (non-scrambled) user code. In an embodiment, these random digits are random difference digits, selected from a range that permits them to be added to digits of the user code to result in sums less than 10. Thus, central computer 120 generates random differences based on the user code (step 220). These differences are such that the user may add these differences to digits of the user code, once the user is informed of the differences, and then supply the user code as modified by the addition of random differences, i.e. the scrambled user code, to the central computer 120. Thus, after generating the random differences, central computer 120 prompts the user to modify the user code with the random values and enter the result in keypad 106 (step 221). As will be appreciated, using this technique, central computer is able to validate the user code, because only a possessor of the user code (i.e. the user himself) will be able to supply computer 120 with the correct scrambled user code after being supplied with the random differences. Further, the modified or scrambled user code, which is the actual number entered by the user into the keypad 106, is partially or completely unrelated to the original user code, since it is produced by adding thereto random differences. Thus, any unauthorized third party who eavesdrops and sees or hears the scrambled user code entered by the user receives no useful information, and learns nothing of the user's user code.

To validate the scrambled user code entered, central computer 120 either compares this code to the scrambled user code which the computer has already prepared, or the computer reverses the randomization process on the information entered by the user and compares this to the user's original user code which is stored centrally at the computer.

For instance, for simplicity assume a user code of 2468. This is known to the central computer 120 and also to the authentic user. Central computer 120 generates a scramble key of, say, 4421. This can be used to add to the user code or 2468 to result in a scrambled user key of 6889. Preferably, the digits of the scramble key are chosen so they may be easily added to (or subtracted from) corresponding digits of the original user code without resulting in a negative number of multi-digit number (i.e., 10 or greater). For example, if in generating the random scramble key, the digit “9” results for the first digit of the random scramble key, it is rejected and a new one selected that is less than 8 because if 9 is added to 2, 11 results, instead of a one-digit digit of the scrambled user code.

Thus, after generating an acceptable random scramble key, central computer 120 now knows the user code, the random scramble key, and the scrambled user code that will result from applying the random scramble key to the user code in a specified way. The user supposedly has access to the user code only. Thus, central computer provides the random scramble key to the user and asks the user to modify the user code known to user, with the provided random scramble key, to generate a scrambled user code and send this back to central computer for verification. For example, if central computer 120 asks the user to add 4421 to his user code, where 4421 is a set of random differences calculated so that they may easily be added to the user code without arithmetic carryover, then the result is 2468+4421=6889. If the user enters 6889, central computer knows that the user must have known the user code was 2468 in order to get 6889 by adding 4421. For further security, the central computer 120 may be configured to be able to request either additions or subtractions from a given digit of the user code, but ensuring that no carryovers or borrowing is necessary, in order to simplify the arithmetic for the user, as further explained hereinbelow.

As a further example, consider a user at an airport, desiring to make a long-distance telephone call to a destination and to charge the call to the calling card account of the user at a particular long distance company. In prior art techniques, the user dials a special phone number or codes the desired destination telephone number in a particular way, such that the long distance company's computer is activated and asks for the user's account number (including its PIN code). After the user enters this information it is verified by the computer and, if accurate, the call is allowed to be placed to the destination phone number. In one prior art method, the user calls a special telephone number, such as a toll-free number that reaches the long-distance company, and the user then is requested to enter the destination phone number plus account code information. In another prior art technique, the user merely enters a special prefix (such as “0” or “10-ATT-0” to place an AT&T® credit card call on a non-AT&T telephone) before the destination number, and a special tone or short message generated by the computer alerts the user to enter the account code information necessary to charge the call to the user's account.

In the current invention, a similar overall technique may be utilized, but instead of requesting the user for the user's account information, the computer automatically performs the following (or similar) steps. In a preferred embodiment, a method of randomization is selected or is utilized, which is to be used by the user to randomize (scramble) the user code to produce a scrambled user code. For instance, if the user's account information constitutes a 10-digit account code plus a 4-digit PIN code, the randomization method utilized might be to randomize only the 4-digit PIN code. In this example, the computer would first request the user to enter only the account code. The computer would then generate four random numbers (each between 0 and 9) that may be easily added to or subtracted from each digit of the PIN number to provide another (single) digit, and asks the user to, in turn, enter subsequent digits of the PIN number plus or minus the respective random number that has been generated for that PIN digit.

Thus, suppose the user's PIN code is 1234. Instead of prompting the user to enter the PIN code (e.g., by a tone, as in the prior art) and the user entering the actual PIN code “1234” in the keypad (whereby the PIN may be stolen by an eavesdropper), the computer will generate random digits for each of the four digits. These random digits together constitute the random scramble code. Thus, the computer may generate a 3 to be added to the first digit 1 (which yields 4, another single digit); a 6 to be added to the second digit 2 (yielding 8, a single digit); a 2 to be added to the third digit 3 (yielding 5); and a 4 to be subtracted from the fourth digit 4 (yielding 0). Thus, the user is told by the computer: “Please add 3 to the first PIN digit” , whereupon the user mentally recalls that the first digit is 1 and adds 3 thereto to realize that 4 is the sum, and thus enters 4 on the telephone keypad. This continues until the user has entered the randomized or scrambled version of “1234,” or “4850” in this example. In this example, the user code is 1234; the scramble key constitutes the random digits to be selectively added to or subtracted from the corresponding digit of the user code; and the scrambled user code is 4850. The computer may easily verify that the response provided by the user in response to the request to modify the user code to result in a scrambled user code, is the correct information and allow the telephone call to proceed. This may be done by the computer treating the code received from the user as an “input code” and comparing this input code to the expected input code, i.e. the scrambled user code. If the input code input by the user matches the scrambled user code, the computer determines that the user has possession of the user code.

As will be understood, a third party observing the “4850” digit sequence entered by the user does not thereby gain the user's PIN code “1234,” since the third party will not know what the random numbers were that were added by (or subtracted from, as the case may be) the user to the memorized user code. The eavesdropper may not even know that it is a scrambled code being entered, but may erroneously believe the user is entering some actual user code. For subsequent calls, a different random scramble key is used (since at least some of the numbers thereof are randomly generated), so that “4850” has no better chance of being the correct PIN code than any other random number the third party could try. Also, even if the third party observes multiple consecutive calls by the user the third party will only see several random 4-digit numbers entered that are statistically unrelated, or at least very weakly related, to the user's PIN code (user code).

In an embodiment, a random scramble key digit between 0 and 9 is selected for each digit of the user code. The scramble key digit is then either added to, or subtracted from, the corresponding digit of the user code, depending on which operation does not result in a negative or two-digit result. Thus, the scramble key contains digits, some of which may need to be added to, and some subtracted from, the corresponding user code, to produce the scrambled user code. In an alternative embodiment, all the digits of the random scramble key are selected so that they may be added to the user code; in another alternative embodiment, all the digits of the random scramble key are selected so that they may be subtracted to the user code.

As will be understood, several variations of the above-described embodiments may be implemented. First, as explained above, the user may be given an option before this procedure to either choose the “security” mode or not. Thus, users who are at a friend's house or other safe location, or users that are annoyed by the randomizing procedure and consider it a bother to add or subtract numbers from their PIN or account codes (for example because they are unable to perform simple arithmetic), can choose to avoid the procedure. In alternative preferred embodiments, central computer 120 may ask only for the user to randomize certain digits of the PIN code, rather than all digits, if less security can be tolerated for greater convenience in use. For instance, the computer may ask the user to enter the PIN code “with 3 added to the second digit and 5 added to the fourth digit”. Although this result produces a number that is not completely randomly independent of the original code, it may still, according to a reasonable commercial determination, randomize the information enough to prevent or minimize fraud while providing the minimal amount of inconvenience to the user. Alternatively, central computer 120 may ask for random variations of the entire account code itself for even greater security.

It will be appreciated that only certain random digits were selected in the example illustrated above to add or subtract from PIN digits for ease of use of the user. For instance computer 120 might generate the random number 3 but this would not be a good number to ask the user to subtract from a PIN digit of 2, as a user might be confused about entering −1, or might not understand negative numbers. Further, a random digit of 9 added to a PIN digit of 8 would call for the user to enter two digits 17 in place of the single PIN digit 8. This technique may be used or not, in accordance with the present invention, depending upon commercial determinations. Either way a random result is produced that will serve to protect from fraud.

In another embodiment, the central computer may provide an entire random scramble key and ask the user to modify the user code based on this key, to result in some scrambled user code. For example, if the user code is 1234, the computer may determine a random scramble key of 117, and ask the user to add the number “117” to the code. The user should then calculate to determine the scrambled user code 1351. The random scramble key, or constituent parts thereof, may be applied to parts of all of the user code in ways other than addition and subtraction, to produce the scrambled user code, such as multiplication, modulo addition, and so on. For example, in a simple scramble scheme, the central computer may ask the user to enter the middle two digits only of the user code; in this case, the middle two digits constitute the scrambled user code which is related to the original user code by the scramble key and method. Or, the scramble key may be “plus-one,” meaning that the user is requested to shift the user code to the right, i.e. 1234 becomes 4123, and so forth.

In alternative embodiments, the present invention may be used to prevent eavesdropping on any user information entered by the user, whether numeric or alphanumeric, and whether a short code or longer blocks of information. In any event, the user information which is to be protected is referred to herein as a user code, which is modified by some type of random scramble key to produce a scrambled user code related to the user code only by the random scramble key.

It will be understood that, in general, the present invention may be utilized any time a remotely-located agent or computer requests a user entering information into a potentially publicly visible terminal (where “visible” in this sense includes all forms of eavesdropping on all forms of information entry) such as a telephone with a keypad. The computer in general supplies the user with certain random key(s) or other form of randomizing method and asks the user to use these random keys to provide a random (scrambled) version of the information to the computer. Thus, the user may still supply confirming information to the computer or agent that the user indeed is in possession of the confidential information, without the user publicly exhibiting the actual data, but only a random version of it.

As will be understood, in alternative preferred embodiments a human agent may be employed to perform the heretofore described functions of central computer 120.

In other alternative embodiments, the “secure” mode may always be activated for all customers or particular customers, or each customer may designate ahead of time whether secure mode is to be offered or not when account transactions are made.

As will further be understood, although account-related transactions associated with remote terminals is described hereinabove, in alternative preferred embodiments users may need to enter account or other confidential information into a data entry terminal that is not necessarily remotely connected with a remote database, computer, or other facilities of the company managing the account. For instance, a user may enter data into a data entry terminal such as a self-contained automatic teller machine in an airport or other public location, which is able to process the user's transaction without remote communication. In this case, for example, the user may listen to instructions or data entry prompts from a hand-held speaker similar to that used with telephones, so that the randomized queries directed to the user are not audible to unauthorized users who may be nearby. The user may then supply his account or other information after randomizing it in accordance with the terminal's prompts, for instance by speaking the information vocally into a microphone in the mouthpiece or by entering the data into a keypad. Similarly, a telephone or telecommunications terminal may conceivably perform locally database and related functions described hereinabove. In another embodiment, a self-contained device such as the user's laptop may require the user to enter confidential passwords or other user codes to access some information or applications. In this context as well, an embodiment of the present invention may be utilized.

The present invention can benefit the user and the account company by reducing the costs associated resulting from instances of fraud and from the very possibility of such fraud, and should also make the services of a company utilizing the techniques of the present invention more attractive to users desiring in confidential account numbers and related information.

The present invention can also be embodied in the form of computer-implemented processes and apparatuses for practicing those processes. The present invention can also be embodied in the form of computer program code embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted as a propagated computer data or other signal over some transmission or propagation medium, such as over electrical wiring or cabling, through fiber optics, or via electromagnetic radiation, or otherwise embodied in a carrier wave, wherein, when the computer program code is loaded into and executed by a computer, the computer becomes an apparatus for practicing the invention. When implemented on a future general-purpose microprocessor sufficient to carry out the present invention, the computer program code segments configure the microprocessor to create specific logic circuits to carry out the desired process.

It will be understood that various changes in the details, materials, and arrangements of the parts which have been described and illustrated above in order to explain the nature of this invention may be made by those skilled in the art without departing from the principle and scope of the invention as recited in the following claims.

What is claimed is:

1. A method for verifying possession of a user code by a user using a data entry terminal, the method comprising the steps of:
(a) generating a scramble key;
(b) providing the scramble key to the user and prompting the user to generate an input code by modifying the user code in accordance with the scramble key; and
(c) receiving the input code from the user.

2. The method of claim 1, further comprising the steps of:
(d) determining whether the user used the user code to generate the input code; and
(e) permitting access by the user of an account associated with the user accordance with the determination of step (d).

3. The method of claim 2, wherein:
step (d) comprises the step of determining whether the user used the user code to generate the input code by comparing the input code received from the user to an expected input code, wherein the expected input code is a scrambled input code produced by modifying the user code in accordance with the scramble key; and
step (e) comprises the step of permitting access by the user of the account associated with the user only if the input code matches the expected input code.

4. The method of claim 1, wherein the data entry terminal is a public telephone.

5. The method of claim 4, wherein:
said scramble key is a random scramble key generated in response to activation by the user; and
activation by the user comprises the user placing a charge telephone call; and
further comprising the steps of:
(d) determining whether the user used the user code to generate the input code; and
(e) placing the telephone call and charging the telephone call to an account associated with the user code only if the user is determined to have used the user code to generate the input code.

6. The method of claim 1, wherein step (a) comprises the steps of:
(1) accessing the user code from a database; and
(2) generating a random difference value for at least one digit of the user code, wherein if the difference value for a digit of the at least one digit is positive then the digit plus the difference value is not greater than 9 and if the difference value for the digit is negative then the digit minus the difference value is not less than 0, wherein said scramble key comprises said random difference values.

7. The method of claim 6, wherein the user code is a personal-identification number (PIN) code.

8. The method of claim 6, wherein step (b) comprises the step of:
(1) for at least one digit of the user code, prompting the user to add or subtract the difference value of the scramble key from each of the at least one digits, in accordance with whether the difference value is positive or negative.

9. An apparatus for verifying possession of a user code by a user using a data entry terminal, the apparatus comprising:
(a) means for generating a scramble key;
(b) means for providing the scramble key to the user and prompting the user to generate an input code by modifying the user code in accordance with the scramble key; and
(c) means for receiving the input code from the user.

10. The apparatus of claim 9, further comprising:
(d) means for determining whether the user used the user code to generate the input code; and
(e) means for permitting access by the user of an account associated with the user accordance with the determination of means (d).

11. The apparatus of claim 10, wherein:
means (d) comprises means for determining whether the user used the user code to generate the input code by comparing the input code received from the user to an expected input code, wherein the expected input code is a scrambled input code produced by modifying the user code in accordance with the scramble key; and
means (e) comprises means for permitting access by the user of the account associated with the user only if the input code matches the expected input code.

12. The apparatus of claim 9, wherein the data entry terminal is a public telephone.

13. The apparatus of claim 12, wherein:
said scramble key is a random scramble key generated in response to activation by the user; and
activation by the user comprises the user placing a charge telephone call; and
the apparatus further comprising:
(d) means for determining whether the user used the user code to generate the input code; and
(e) means for placing the telephone call and charging the telephone call to an account associated with the user code only if the user is determined to have used the user code to generate the input code.

14. The apparatus of claim 9, wherein means (a) comprises:
(1) means for accessing the user code from a database; and
(2) means for generating a random difference value for at least one digit of the user code, wherein if the difference value for a digit of the at least one digit is positive then the digit plus the difference value is not greater than 9 and if the difference value for the digit is negative then the digit minus the difference value is not less than 0, wherein said scramble key comprises said random difference values.

15. The apparatus of claim 14, wherein the user code is a personal-identification number (PIN) code.

16. The apparatus of claim 14, wherein means (b) comprises means for prompting the user to add or subtract, for at least one digit of the user code, the difference value of the scramble key from each of the at least one digits, in accordance with whether the difference value is positive or negative.

17. A computer-readable medium having stored thereon a plurality of instructions for verifying possession of a user code by a user using a data entry terminal, wherein the plurality of instructions, when executed by a processor, cause the processor to perform the steps of:
(a) generating a scramble key;
(b) providing the scramble key to the user and prompting the user to generate an input code by modifying the user code in accordance with the scramble key; and
(c) receiving the input code from the user.

18. The computer-readable medium of claim 17, wherein said plurality of instructions cause the processor to perform the further steps of:
(d) determining whether the user used the user code to generate the input code; and
(e) permitting access by the user of an account associated with the user accordance with the determination of step (d).

19. The computer-readable medium of claim 19, wherein:
step (d) comprises the step of determining whether the user used the user code to generate the input code by comparing the input code received from the user to an expected input code, wherein the expected input code is a scrambled input code produced by modifying the user code in accordance with the scramble key; and
step (e) comprises the step of permitting access by the user of the account associated with the user only if the input code matches the expected input code.

20. A propagated computer data signal transmitted via a propagation medium, the computer data signal comprising a plurality of instructions for verifying possession of a user code by a user using a data entry terminal, wherein the plurality of instructions, when executed by a processor, cause the processor to perform the steps of
(a) generating a scramble key;
(b) providing the scramble key to the user and prompting the user to generate an input code by modifying the user code in accordance with the scramble key; and
(c) receiving the input code from the user.
